(19) United States
(12) Patent Application Publication
(10) Pub. No.: US 2026/0194750 A1
(43) Pub. Date: Jul. 9, 2026

(54) PICTURE GENERATION UNIT (PGU), OPTICAL ENGINE MODULE, AND FOCUS FINE-TUNING MECHANISM OF OPTICAL ENGINE MODULE

(71) Applicant: MEGAFORCE COMPANY LIMITED, New Taipei City (TW)

(72) Inventors: Yuh-Hom Tseng, NEW TAIPEI CITY (TW); SHI-CHENG LAI, NEW TAIPEI CITY (TW); CHUNG-YU WEI, NEW TAIPEI CITY (TW)

(21) Appl. No.: 19/256,172

(22) Filed: Jul. 1, 2025

Related U.S. Application Data
(60) Provisional application No. 63/741,987, filed on Jan. 6, 2025.

(30) Foreign Application Priority Data
May 6, 2025 (TW) 114116856

(51) Int. Cl. G02B 27/01

(52) U.S. Cl. CPC G02B 27/0101; G02B 27/0149; G02B 2027/0112; G02B 2027/0154

(57) ABSTRACT

The present disclosure provides a picture generation unit (PGU), an optical engine module, and a focus fine-tuning mechanism of an optical engine module. The optical engine module includes a frame, a light-combining lens disposed on the frame, a plurality of laser emitters disposed on the frame, a beam-shaping lens corresponding in position to the light-combining lens, and a focus fine-tuning mechanism. The focus fine-tuning mechanism includes a fixing sleeve fixed to the frame, an inner lens fixed to the fixing sleeve, a focus adjustment sleeve movably assembled to the fixing sleeve, and an outer lens that is fixed to the focus adjustment sleeve. The beam-shaping lens is located in a space defined by the fixing sleeve and the frame. The outer lens is configured to allow a light beam passing through the beam-shaping lens and the inner lens to travel therethrough for forming a focused beam.

### CROSS-REFERENCE TO RELATED PATENT APPLICATION

This application claims the benefit of priority to Taiwan Patent Application No. 114116856, filed on May 6, 2025. The entire content of the above identified application is incorporated herein by reference.

This application claims the benefit of priority to the U.S. Provisional Patent Application Ser. No. 63/741,987, filed on Jan. 6, 2025, which application is incorporated herein by reference in its entirety.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a picture generation technology, and more particularly to a picture generation unit (PGU), an optical engine module, and a focus fine-tuning mechanism of the optical engine module.

### BACKGROUND OF THE DISCLOSURE

A conventional picture generation unit (PGU) has a requirement for miniaturization, but the configuration of the conventional PGU is prone to generating issues such as insufficient brightness or insufficient image clarity after miniaturization.

### SUMMARY OF THE DISCLOSURE

In response to the above-referenced technical inadequacies, the present disclosure provides a picture generation unit (PGU), an optical engine module, and a focus fine-tuning mechanism of the optical engine module for effectively improving on the issues associated with conventional picture generation units.

In order to solve the above-mentioned problems, one of the technical aspects adopted by the present disclosure is to provide a picture generation unit (PGU), which includes a housing, two optical engine modules, two optical engine modules, a micro electro mechanical systems (MEMS) scanning module, and a diffuser. The two optical engine modules are arranged adjacent to each other and are assembled in the housing. Each of the two optical engine modules includes a frame, a light-combining lens, a plurality of laser emitters, a beam-shaping lens, and a focus fine-tuning mechanism. The light-combining lens is disposed on the frame and has a plurality of light-input surfaces and a light-output surface. The laser emitters are spaced apart from each other and are assembled to the frame. The laser emitters respectively face toward the light-input surfaces. The laser emitters are configured to respectively emit a plurality of laser beams toward the light-input surfaces, and the light-combining lens is configured to combine the laser beams therein into a mixed beam having a first beam shape and is configured to enable the mixed beam to be emitted from the light-output surface. The beam-shaping lens corresponds in position to the light-output surface and is configured to shape the mixed beam to form a shaped beam having a second beam shape that is different from the first beam shape. The focus fine-tuning mechanism includes a fixing sleeve, an inner lens, a focus adjustment sleeve, and an outer lens. The fixing sleeve is fixed to the frame. The beam-shaping lens is located in a space defined by the fixing sleeve and the frame. The inner lens is fixed to the fixing sleeve and is arranged adjacent to the beam-shaping lens. The inner lens is configured to collimate the shaped beam. The focus adjustment sleeve is movably assembled to the fixing sleeve. The outer lens is fixed to the focus adjustment sleeve. The outer lens has a concave surface facing toward the inner lens and a convex surface that is opposite to the concave surface. The outer lens is configured to allow the shaped beam to pass therethrough so as to form a focused beam that travels along a central axis of the focus fine-tuning mechanism. The MEMS scanning module is assembled in the housing. The central axes respectively corresponding to the two optical engine modules are intersected at the MEMS scanning module and have an angle therebetween that is within a range from 20 degrees to 45 degrees. The diffuser is assembled to the housing and corresponds in position to the MEMS scanning module. The MEMS scanning module is configured to receive the focused beams emitted from the two optical engine modules and is configured to emit an image beam toward the diffuser.

In order to solve the above-mentioned problems, another one of the technical aspects adopted by the present disclosure is to provide an optical engine module, which includes a frame, a light-combining lens, a plurality of laser emitters, a beam-shaping lens, and a focus fine-tuning mechanism. The light-combining lens is disposed on the frame and has a plurality of light-input surfaces and a light-output surface. The laser emitters are spaced apart from each other and are assembled to the frame. The laser emitters respectively face toward the light-input surfaces. The laser emitters are configured to respectively emit a plurality of laser beams toward the light-input surfaces, and the light-combining lens is configured to combine the laser beams therein into a mixed beam having a first beam shape and is configured to enable the mixed beam to be emitted from the light-output surface. The beam-shaping lens corresponds in position to the light-output surface and is configured to shape the mixed beam to form a shaped beam having a second beam shape that is different from the first beam shape. The focus fine-tuning mechanism includes a fixing sleeve, an inner lens, a focus adjustment sleeve, and an outer lens. The fixing sleeve is fixed to the frame. The beam-shaping lens is located in a space defined by the fixing sleeve and the frame. The inner lens is fixed to the fixing sleeve and is arranged adjacent to the beam-shaping lens. The inner lens is configured to collimate the shaped beam. The focus adjustment sleeve is movably assembled to the fixing sleeve. The outer lens is fixed to the focus adjustment sleeve. The outer lens has a concave surface facing toward the inner lens and a convex surface that is opposite to the concave surface. The outer lens is configured to allow the shaped beam to pass therethrough so as to form a focused beam that travels along a central axis of the focus fine-tuning mechanism.

In order to solve the above-mentioned problems, yet another one of the technical aspects adopted by the present disclosure is to provide a focus fine-tuning mechanism of an optical engine module configured to adjust a light beam that passes therethrough. The focus fine-tuning mechanism includes a fixing sleeve, an inner lens, a focus adjustment sleeve, and an outer lens. The inner lens is fixed to the fixing sleeve and is configured to collimate the light beam. The focus adjustment sleeve is movably assembled to the fixing sleeve. The outer lens is fixed to the focus adjustment sleeve. The outer lens has a concave surface facing toward the inner lens and a convex surface that is opposite to the concave surface. The outer lens is configured to allow the light beam to pass therethrough so as to form a focused beam that travels along a central axis of the focus fine-tuning mechanism.

Therefore, any one of the PGU, the optical engine module, and the focus fine-tuning mechanism of the present disclosure can be provided to effectively prevent a laser beam scanning (LBS) configuration from exhibiting a speckle issue, such that the PGU can be miniaturized by adopting the LBS configuration while maintaining sufficient brightness and high definition.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic perspective view showing a picture generation unit (PGU) applied to an augmented reality head-up display (AR HUD) according to the present disclosure;

FIG. 2 is a schematic top view of the PGU according to the present disclosure;

FIG. 3 is a schematic cross-sectional view taken along line III-III of FIG. 2;

FIG. 4 is a schematic perspective view of an optical engine module according to the present disclosure;

FIG. 5 is a schematic exploded view of FIG. 4;

FIG. 6 is a schematic exploded view of a focus fine-tuning mechanism shown in FIG. 5;

FIG. 7 is a schematic exploded view of the focus fine-tuning mechanism shown in FIG. 5 from another angle of view;

FIG. 8 is a schematic cross-sectional view taken along line VIII-VIII of FIG. 4;

FIG. 9 is a schematic view showing a light beam path defined by a part of the optical engine module of FIG. 8; and

FIG. 10 is a schematic cross-sectional view of the focus fine-tuning mechanism according to the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

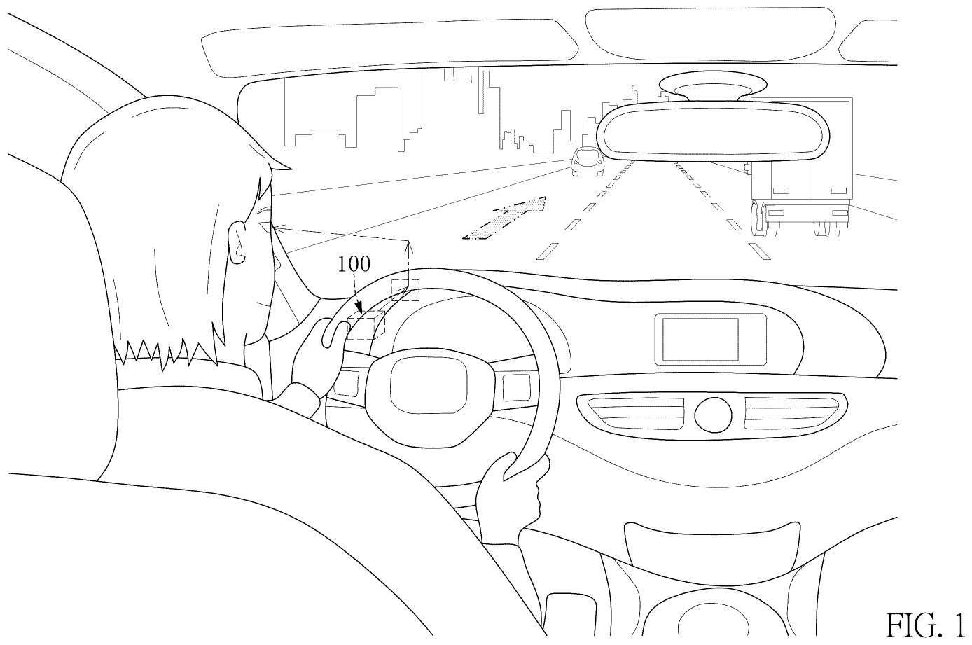

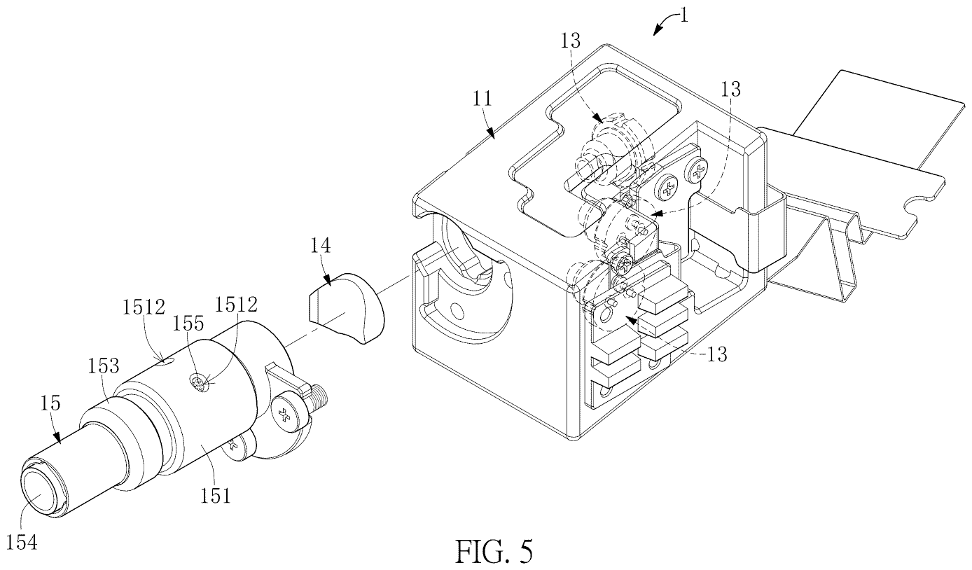

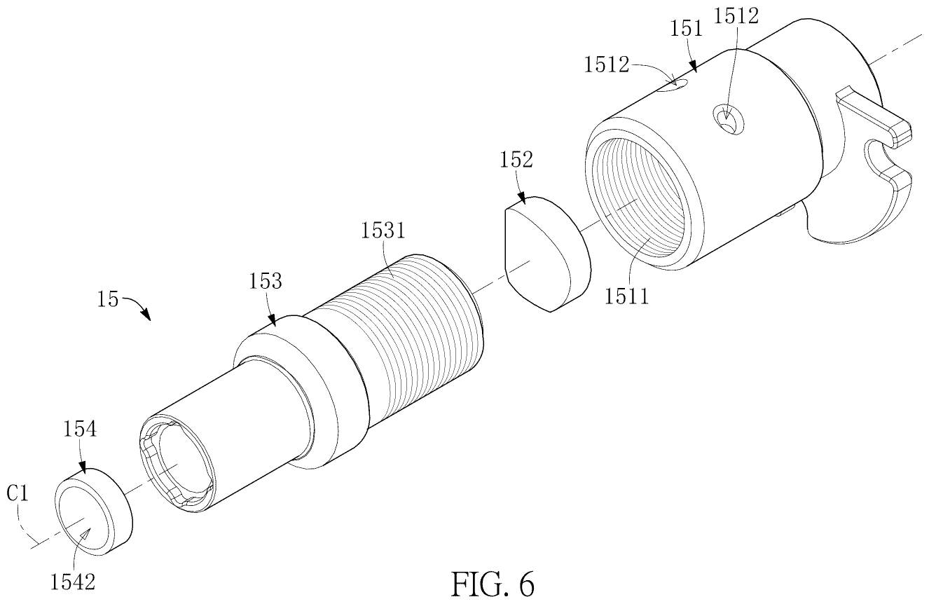

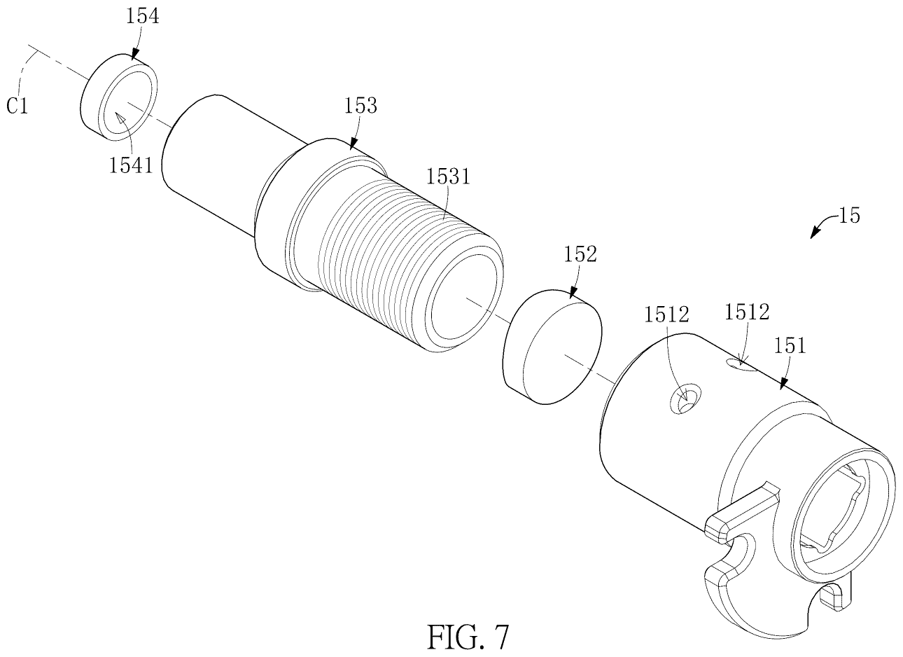

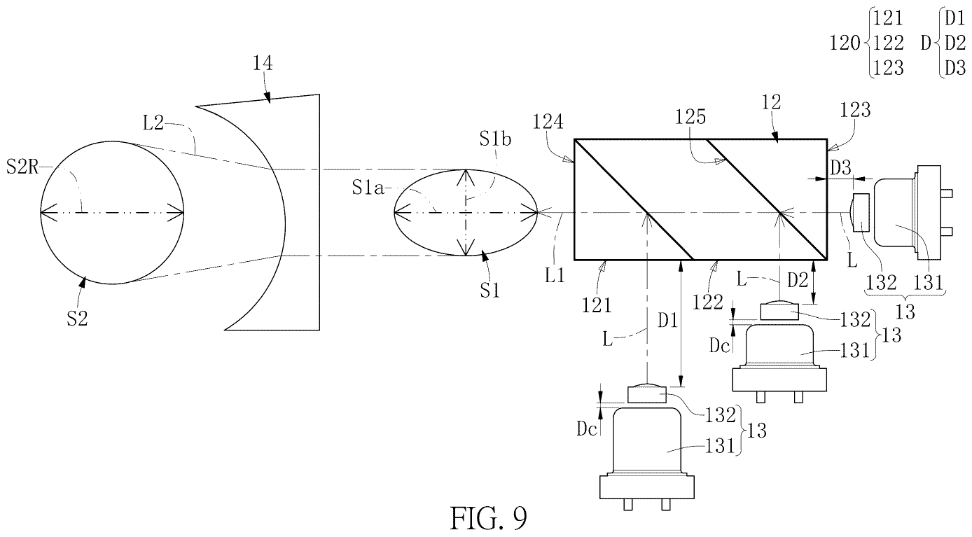

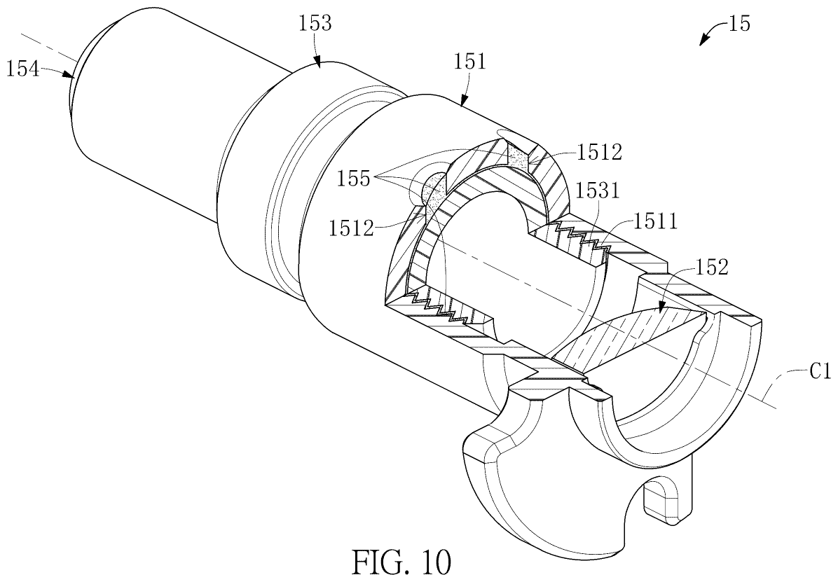

Referring to FIG. 1 to FIG. 10, an embodiment of the present disclosure is provided. As shown in FIG. 1, the present embodiment provides a picture generation unit (PGU) 100 that is applied to an augmented reality head-up display (AR HUD) of the driver's seat in a vehicle, but the present disclosure is not limited thereto.

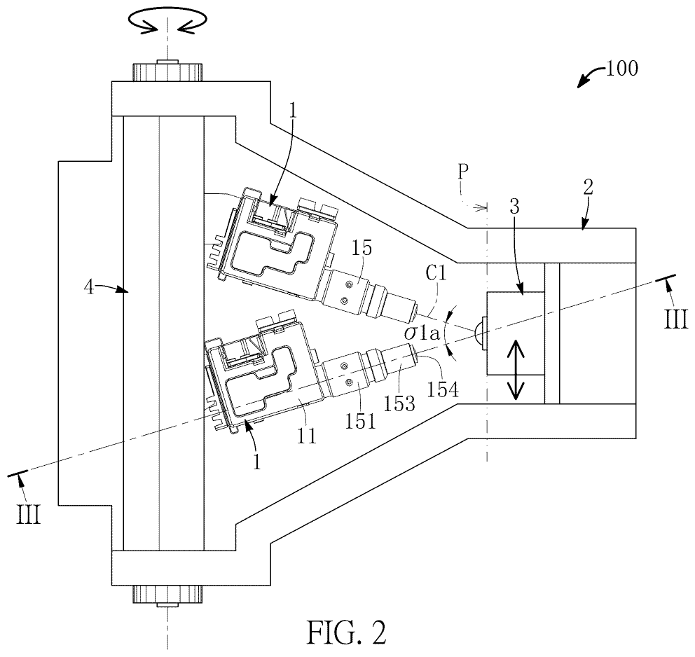

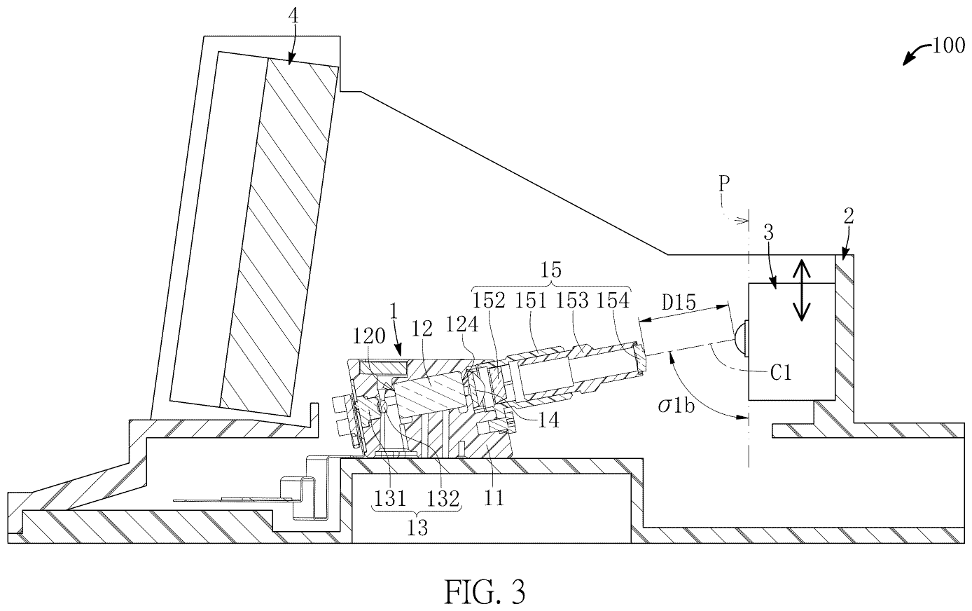

As shown in FIG. 2 and FIG. 3, the PGU 100 in the present embodiment includes a housing 2, two optical engine modules 1 arranged adjacent to each other and assembled in the housing 2, a micro electro mechanical systems (MEMS) scanning module 3 assembled in the housing 2, and a diffuser 4 that is assembled to the housing 2, but the present disclosure is not limited thereto. For example, in other embodiments of the present disclosure not shown in the drawings, the optical engine module 1 can be independently used (e.g., sold) or can be used in cooperation with other components.

The housing 2 has a plurality of structures (not labeled in the drawings) for assembling the two optical engine modules 1, the MEMS scanning module 3, and the diffuser 4, such that the two optical engine modules 1, the MEMS scanning module 3, and the diffuser 4 can be located at a predetermined position of the housing 2.

In the present embodiment, each of the two optical engine modules defines a central axis C1, and a light beam emitted from the each of the two optical engine modules 1 travels along the central axis C1. Moreover, the central axes C1 respectively corresponding to the two optical engine modules 1 are intersected at the MEMS scanning module 3 and have an angle σ1a therebetween that is within a range from 20 degrees to 45 degrees, thereby enabling the two optical engine modules 1 and the MEMS scanning module 3 to provide a better performance through a positional cooperation thereof.

Specifically, the MEMS scanning module 3 is movably assembled to the housing 2 and is movable on a plane P, so that the MEMS scanning module 3 can precisely correspond in position to the two optical engine modules 1. A projecting angle σ1b between the central axis C1 of each of the two optical engine modules 1 and the plane P is within a range from 76 degrees to 82 degrees, but the present disclosure is not limited thereto.

Moreover, the diffuser 4 corresponds in position to the MEMS scanning module 3, and the diffuser 4 in the present embodiment is rotatably assembled to the housing 2, such that the diffuser 4 can precisely correspond in position to the MEMS scanning module 3. Accordingly, when an image beam emitted from the MEMS scanning module 3 is projected outside of the PGU 100 through the diffuser 4, the image beam can provide a better display effect. Furthermore, a distance between the diffuser 4 and the MEMS scanning module 3 can be effectively reduced through the configuration of the PGU 100, thereby facilitating miniaturization of the PGU 100.

It should be noted that, as the two optical engine modules 1 in the present embodiment are of substantially the same structure and are in mirror symmetrical arrangement, the following description discloses the structure of just one of the two optical engine modules 1 and then discloses the connection relationship between the two optical engine modules 1 and other components, but the present disclosure is not limited thereto. For example, in other embodiments of the present disclosure not shown in the drawings, the two optical engine modules 1 can be of different structures or can be in a non-mirror symmetrical arrangement.

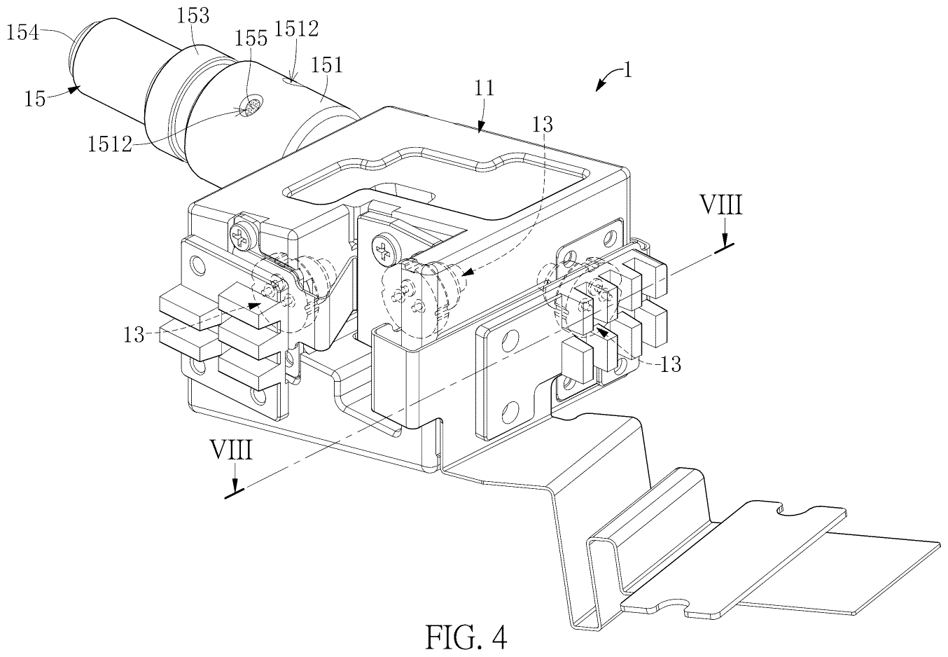

As shown in FIG. 4 to FIG. 8, the optical engine module 1 in the present embodiment includes a frame 11 fixed in the housing 2, a light-combining lens 12 disposed on the frame 11, a plurality of laser emitters 13 spaced apart from each other and assembled to the frame 11, a beam-shaping lens 14 corresponding in position to the light-combining lens 12, and a focus fine-tuning adjustment mechanism 15 that is assembled to the frame 11.

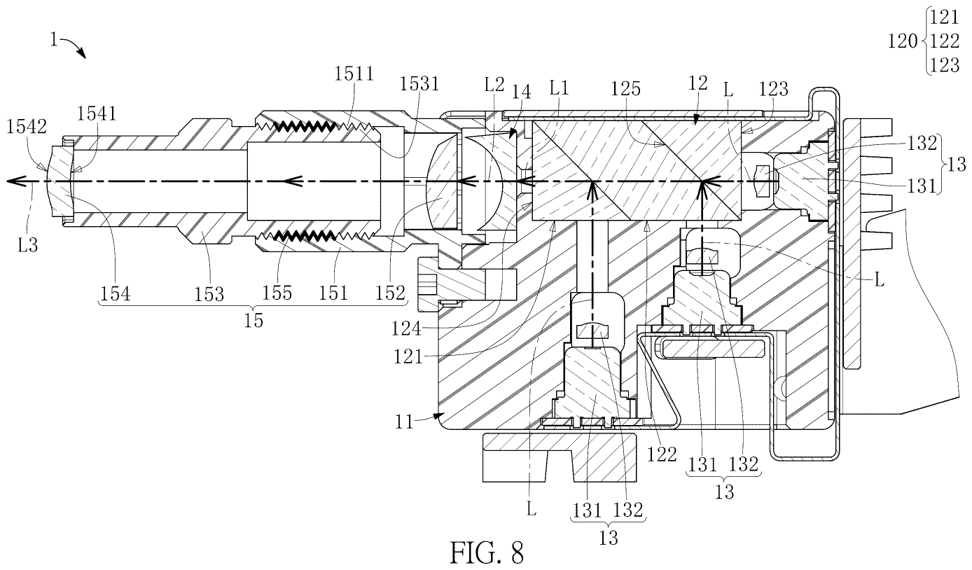

As shown in FIG. 8 to FIG. 10, the light-combining lens 12 has a plurality of light-input surfaces 120 and a light-output surface 124, and the structural relationship of the light-input surfaces 120 and the light-output surface 124 can be adjusted or changed according to practical requirements. In order to clearly describe the present embodiment, the light-combining lens 12 described in the following description is a rectangular cylinder, but the present disclosure is not limited thereto.

Specifically, the light-input surfaces 120 include a first light-input surface 121 arranged adjacent to the light-output surface 124, a second light-input surface 122 arranged adjacent to the first light-input surface 121, and a third light-input surface 123 that is arranged away from the light-output surface 124. The first light-input surface 121 and the second light-input surface 122 are arranged on a long lateral surface of the light-combining lens 12 and are connected to each other so as to be coplanar with each other. The light-output surface 124 and the third light-input surface 123 are respectively arranged on two opposite ends of the light-combining lens 12 and are perpendicularly connected to the first light-input surface 121 and the second light-input surface 122, respectively. In the present embodiment, the light-combining lens 12 has a plurality of slanting surfaces 125 arranged in an interior thereof, and optical parameters (e.g., transmittance and reflectivity) of any one of the slanting surfaces 125 can be adjusted or changed according to practical requirements, but the present disclosure is not limited thereto.

The laser emitters 13 respectively face toward the light-input surfaces 120 of the light-combining lens 12. The laser emitters 13 are configured to respectively emit a plurality of laser beams L toward the light-input surfaces 120, and the light-combining lens 12 is configured to combine the laser beams L therein into a mixed beam L1 having a first beam shape S1 and is configured to enable the mixed beam L1 to be emitted from the light-output surface 124. It should be noted that the frame 11 of the present embodiment is an opaque structure, such that when the laser beams L emitted from the laser emitters 13 travel in the frame 11, the laser beams L are not scattered outside of the frame 11.

In the present embodiment, each of the laser emitters 13 includes a laser diode 131 and a collimation lens 132 that corresponds in position to the laser diode 131. In each of the laser emitters 13, the collimation lens 132 is arranged between the laser diode 131 and the corresponding light-input surface 120, and the collimation lens 132 is spaced apart from the laser diode 131 by a collimation distance Dc and is spaced apart from the corresponding light-input surface 120 by an arrangement distance D. The collimation distances Dc of the laser emitters 13 are equal to each other, and the arrangement distances D of the laser emitters 13 are different from each other.

After considering the wavelengths and positions of the laser beams L of the laser emitters 13, in order to enable the laser beams L to be stably combined into the combined beam L1, the light-input surfaces 120 of the optical engine module 1 and the laser emitters 13 preferably adopt the following relative configuration, but the present disclosure is not limited thereto.

In the present embodiment, the laser emitter 13 (e.g., the laser diode 131) corresponding to the first light-input surface 121 is configured to emit a red laser beam, the laser emitter 13 (e.g., the laser diode 131) corresponding to the second light-input surface 122 is configured to emit a green laser beam, and the laser emitter 13 (e.g., the laser diode 131) corresponding to the third light-input surface 123 is configured to emit a blue laser beam.

Specifically, the arrangement distance D corresponding to the first light-input surface 121 is defined as a first arrangement distance D1; in other words, the first light-input surface 121 is spaced apart from a corresponding one of the laser emitters 13 by the first arrangement distance D1. The arrangement distance D corresponding to the second light-input surface 122 is defined as a second arrangement distance D2; in other words, the second light-input surface 122 is spaced apart from a corresponding one of the laser emitters 13 by the second arrangement distance D2. The arrangement distance D corresponding to the third light-input surface 123 is defined as a third arrangement distance D3; in other words, the third light-input surface 123 is spaced apart from a corresponding one of the laser emitters 13 by the third arrangement distance D3. Furthermore, the first arrangement distance D1 is greater than the second arrangement distance D2, and the second arrangement distance D2 is greater than the third arrangement distance D3, but the present disclosure is not limited thereto.

The beam-shaping lens 14 corresponds in position to (e.g., is arranged adjacent to) the light-output surface 124 of the light-combining lens 12 and is configured to shape the mixed beam L1 to form a shaped beam L2 having a second beam shape S2 that is different from the first beam shape S1. The specific structure and arrangement of the beam-shaping lens 14 can be adjusted or changed according to practical requirements, so as to enable the first beam shape S1 to be shaped into the second beam shape S2. In the present embodiment, the first beam shape S1 is an ellipse having a major axis S1a and a minor axis S1b, and the second beam shape S2 is a circle having a radius S2R that is equal to the major axis S1a.

The focus fine-tuning mechanism 15 includes a fixing sleeve 151, an inner lens 152 fixed to the fixing sleeve 151, a focus adjustment sleeve 153 movably assembled to the fixing sleeve 151, and an outer lens 154 that is fixed to the focus adjustment sleeve 153. A distance between the inner lens 152 and the outer lens 154 can be adjusted by moving the focus adjustment sleeve 153 relative to the fixing sleeve 151, and the inner lens 152 and the outer lens 154 are arranged along the central axis C1. In other words, the central axis C1 can be regarded as being defined by the inner lens 152 and the outer lens 154 of the focus fine-tuning mechanism 15.

Specifically, the fixing sleeve 151 is fixed to the frame 11, so that the beam-shaping lens 14 is located in a space defined by the fixing sleeve 151 and the frame 11, and the inner lens 152 is arranged adjacent to the beam-shaping lens 14 and is configured to collimate the shaped beam L2.

In the present embodiment, the fixing sleeve 151 has an inner thread 1511 and at least one thru-hole 1512, the focus adjustment sleeve 153 has an outer thread 1531, and the outer thread 1531 of the focus adjustment sleeve 153 is rotatably screwed to the inner thread 1511 of the fixing sleeve 151 and is partially exposed from the at least one thru-hole 1512. Moreover, the fixing sleeve 151 is configured to allow an adhesive 155 to flow into the at least one thru-hole 1512 and to further extend to a gap between the inner thread 1511 and the outer thread 1531 so as to adhere the fixing sleeve 151 and the focus adjustment sleeve 153.

Accordingly, a focal length of the optical engine module 1 is adjusted by moving the focus adjustment sleeve 153 relative to the fixing sleeve 151, and then a relative position of the focus adjustment sleeve 153 and the fixing sleeve 151 is fixed through the adhesive 155, thereby preventing the operation of the PGU 100 or the optical engine module 1 from being affected by manufacturing tolerance. In the present embodiment, the distance between the inner lens 152 and the outer lens 154 of one of the two optical engine modules 1 can be different from that of another one of the two optical engine modules 1.

In other words, the outer lens 154 of the focus fine-tuning adjustment mechanism 15 is spaced apart from the MEMS scanning module 3 by an adjustment distance D15 (as shown in FIG. 3) that is within a range from 12 mm to 24 mm through a relative movement between the focus adjustment sleeve 153 and the fixing sleeve 151.

In addition, the outer lens 154 is configured to allow the shaped beam L2 to pass therethrough so as to form a focused beam L3 that travels along the central axis C1. In the present embodiment, the outer lens 154 has a concave surface 1541 facing toward the inner lens 152 and a convex surface 1542 that is opposite to the concave surface 1541. In the present embodiment, a curvature of the concave surface 1541 of the outer lens 154 is within a range from 0.07 to 0.075 (e.g., 0.072 being preferable), and a curvature of the convex surface 1542 of the outer lens 154 is within a range from 0.135 to 0.14 (e.g., 0.138 being preferable), thereby providing a better focusing effect, but the present disclosure is not limited thereto.

In summary, the MEMS scanning module 3 is configured to receive the focused beams L3 emitted from the two optical engine modules 3 and is configured to emit the image beam toward the diffuser 4. In other words, the PGU 100 in the present embodiment is configured to adjust the image beam by at least one of the relative movement between the focus adjustment sleeve 153 and the fixing sleeve 151 of the focus fine-tuning adjustment mechanism 15 of each of the two optical engine modules 1, a movement of the MEMS scanning module 3 relative to the housing 2, and a rotation of the diffuser 4 relative to the housing 2, selectively.

Accordingly, an overall size of the PGU 100 provided by the present embodiment can be effectively reduced and can transmit light source energy with high efficiency, so as to have a sufficient brightness (e.g., the brightness being greater than 40 K nits) and a high definition (e.g., a projection area satisfying 15 inches square, and the image quality meeting the relationship of 4 lp/mm MTF>0.7).

Specifically, the PGU 100 is provided with a laser beam scanning (LBS) configuration that has advantages of full color, high brightness (e.g., the brightness being greater than 40 K nits), and low power consumption, thereby being different from and being superior to the liquid crystal display (LCD) projection configuration, the liquid crystal on silicone (LCoS) projection configuration, and the digital light processing (DLP) projection configuration adopted by the conventional PGU.

Moreover, the PGU 100 can be configured to adjust a spot size of the focused beam L3 through the structure of the optical engine module 1 so as to meet the size requirements of the MEMS scanning module 3, and the PGU 100 can be configured to effectively avoid speckles generated on the diffuser 4 through the overall structure configuration. In addition, an effective focal length (EFL) of the PGU 100 in the present embodiment can be controlled to be within a range from 23.5 mm to 33.5 mm, but the present disclosure is not limited thereto.

It should be noted that the focus fine-tuning adjustment mechanism 15 of the optical engine module 1 in the present embodiment is in cooperation with the above components, but the present disclosure is not limited thereto. For example, in other embodiments of the present disclosure not shown in the drawings, the focus fine-tuning adjustment mechanism 15 can be independently used (e.g., sold) or can be used in cooperation with other components. Specifically, the focus fine-tuning mechanism 15 is configured to adjust a light beam that passes therethrough. For example, the inner lens 152 is configured to collimate the light beam, and the outer lens 154 is configured to allow the light beam to pass therethrough so as to form the focused beam L3 that travels along the central axis C1.

### Beneficial Effects of the Embodiment

In conclusion, any one of the PGU, the optical engine module, and the focus fine-tuning mechanism of the present disclosure can be provided to effectively prevent the LBS configuration from exhibiting a speckle issue, such that the PGU can be miniaturized by adopting the LBS configuration while maintaining sufficient brightness and high definition.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A picture generation unit (PGU), comprising:
a housing;
two optical engine modules arranged adjacent to each other and assembled in the housing, wherein each of the two optical engine modules includes:
a frame;
a light-combining lens disposed on the frame and having a plurality of light-input surfaces and a light-output surface;
a plurality of laser emitters spaced apart from each other and assembled to the frame, wherein the plurality of laser emitters respectively face toward the plurality of light-input surfaces, and wherein the plurality of laser emitters are configured to respectively emit a plurality of laser beams toward the plurality of light-input surfaces, and the light-combining lens is configured to combine the plurality of laser beams therein into a mixed beam having a first beam shape and is configured to enable the mixed beam to be emitted from the light-output surface;
a beam-shaping lens corresponding in position to the light-output surface and configured to shape the mixed beam to form a shaped beam having a second beam shape that is different from the first beam shape; and
a focus fine-tuning mechanism including:
a fixing sleeve fixed to the frame, wherein the beam-shaping lens is located in a space defined by the fixing sleeve and the frame;
an inner lens fixed to the fixing sleeve and arranged adjacent to the beam-shaping lens, wherein the inner lens is configured to collimate the shaped beam;
a focus adjustment sleeve movably assembled to the fixing sleeve; and
an outer lens fixed to the focus adjustment sleeve, wherein the outer lens has a concave surface facing toward the inner lens and a convex surface that is opposite to the concave surface, and wherein the outer lens is configured to allow the shaped beam to pass therethrough so as to form a focused beam that travels along a central axis of the focus fine-tuning mechanism;
a micro electro mechanical systems (MEMS) scanning module assembled in the housing, wherein the central axes respectively corresponding to the two optical engine modules are intersected at the MEMS scanning module and have an angle therebetween that is within a range from 20 degrees to 45 degrees; and
a diffuser assembled to the housing and corresponding in position to the MEMS scanning module, wherein the MEMS scanning module is configured to receive the focused beams emitted from the two optical engine modules and is configured to emit an image beam toward the diffuser.

2. The PGU according to claim 1, wherein the MEMS scanning module is movable on a plane, and the diffuser is rotatably assembled to the housing, and wherein the PGU is configured to adjust the image beam by at least one of a relative movement between the focus adjustment sleeve and the fixing sleeve of the focus fine-tuning adjustment mechanism of each of the two optical engine modules, a movement of the MEMS scanning module relative to the housing, and a rotation of the diffuser relative to the housing, selectively.

3. The PGU according to claim 2, wherein a projecting angle between the central axis of the focus fine-tuning adjustment mechanism of each of the two optical engine modules and the plane is within a range from 76 degrees to 82 degrees.

4. The PGU according to claim 1, wherein the outer lens of the focus fine-tuning adjustment mechanism of each of the two optical engine modules is spaced apart from the MEMS scanning module by an adjustment distance that is within a range from 12 mm to 24 mm through the relative movement between the focus adjustment sleeve and the fixing sleeve.

5. The PGU according to claim 1, wherein the first beam shape is an ellipse having a major axis and a minor axis, and the second beam shape is a circle having a radius that is equal to the major axis.

6. The PGU according to claim 1, wherein the plurality of light-input surfaces include:
a first light-input surface arranged adjacent to the light-output surface, wherein the first light-input surface is spaced apart from a corresponding one of the plurality of laser emitters by a first arrangement distance;
a second light-input surface arranged adjacent to the first light-input surface, wherein the second light-input surface is spaced apart from a corresponding one of the plurality of laser emitters by a second arrangement distance; and
a third light-input surface arranged away from the light-output surface, wherein the third light-input surface is spaced apart from a corresponding one of the plurality of laser emitters by a third arrangement distance;
wherein the first arrangement distance is greater than the second arrangement distance, and the second arrangement distance is greater than the third arrangement distance.

7. The PGU according to claim 6, wherein the laser emitter corresponding to the first light-input surface is configured to emit a red laser beam, the laser emitter corresponding to the second light-input surface is configured to emit a green laser beam, and the laser emitter corresponding to the third light-input surface is configured to emit a blue laser beam.

8. The PGU according to claim 6, wherein the first light-input surface is coplanar with the second light-input surface, and the light-output surface and the third light-input surface are respectively arranged on two opposite ends of the light-combining lens and are perpendicularly connected to the first light-input surface and the second light-input surface, respectively.

9. The PGU according to claim 1, wherein, in each of the two optical engine modules, the fixing sleeve has an inner thread and a thru-hole, the focus adjustment sleeve has an outer thread, and the outer thread of the focus adjustment sleeve is rotatably screwed to the inner thread of the fixing sleeve and is partially exposed from the thru-hole, and wherein, in each of the two optical engine modules, the fixing sleeve is configured to allow an adhesive to flow into the thru-hole and to further extend to a gap between the inner thread and the outer thread so as to adhere the fixing sleeve and the focus adjustment sleeve.

10. An optical engine module, comprising:
a frame;
a light-combining lens disposed on the frame and having a plurality of light-input surfaces and a light-output surface;
a plurality of laser emitters spaced apart from each other and assembled to the frame, wherein the plurality of laser emitters respectively face toward the plurality of light-input surfaces, and wherein the plurality of laser emitters are configured to respectively emit a plurality of laser beams toward the plurality of light-input surfaces, and the light-combining lens is configured to combine the plurality of laser beams therein into a mixed beam having a first beam shape and is configured to enable the mixed beam to be emitted from the light-output surface;
a beam-shaping lens corresponding in position to the light-output surface and configured to shape the mixed beam to form a shaped beam having a second beam shape that is different from the first beam shape; and
a focus fine-tuning mechanism including:
a fixing sleeve fixed to the frame, wherein the beam-shaping lens is located in a space defined by the fixing sleeve and the frame;
an inner lens fixed to the fixing sleeve and arranged adjacent to the beam-shaping lens, wherein the inner lens is configured to collimate the shaped beam;
a focus adjustment sleeve movably assembled to the fixing sleeve; and
an outer lens fixed to the focus adjustment sleeve, wherein the outer lens has a concave surface facing toward the inner lens and a convex surface that is opposite to the concave surface, and wherein the outer lens is configured to allow the shaped beam to pass therethrough so as to form a focused beam that travels along a central axis of the focus fine-tuning mechanism.

11. The optical engine module according to claim 10, wherein the first beam shape is an ellipse having a major axis and a minor axis, and the second beam shape is a circle having a radius that is equal to the major axis.

12. The optical engine module according to claim 10, wherein each of the plurality of laser emitters includes:
a laser diode; and
a collimation lens arranged between the laser diode and a corresponding one of the plurality of light-input surfaces, wherein the collimation lens is spaced apart from the laser diode by a collimation distance and is spaced apart from the corresponding light-input surface by an arrangement distance;
wherein the collimation distances of the plurality of laser emitters are equal to each other, and the arrangement distances of the plurality of laser emitters are different from each other.

13. The optical engine module according to claim 12, wherein the plurality of light-input surfaces include:
a first light-input surface arranged adjacent to the light-output surface, wherein the arrangement distance corresponding to the first light-input surface is defined as a first arrangement distance;
a second light-input surface arranged adjacent to the first light-input surface, wherein the arrangement distance corresponding to the second light-input surface is defined as a second arrangement distance; and
a third light-input surface arranged away from the light-output surface, wherein the arrangement distance corresponding to the third light-input surface is defined as a third arrangement distance;
wherein the first arrangement distance is greater than the second arrangement distance, and the second arrangement distance is greater than the third arrangement distance.

14. The optical engine module according to claim 13, wherein the laser diode of the laser emitter corresponding to the first light-input surface is configured to emit a red laser beam, the laser diode of the laser emitter corresponding to the second light-input surface is configured to emit a green laser beam, and the laser diode of the laser emitter corresponding to the third light-input surface is configured to emit a blue laser beam.

15. The optical engine module according to claim 13, wherein the first light-input surface is coplanar with the second light-input surface, and the light-output surface and the third light-input surface are respectively arranged on two opposite ends of the light-combining lens and are perpendicularly connected to the first light-input surface and the second light-input surface, respectively.

16. The optical engine module according to claim 10, wherein the fixing sleeve has an inner thread and a thru-hole, the focus adjustment sleeve has an outer thread, and the outer thread of the focus adjustment sleeve is rotatably screwed to the inner thread of the fixing sleeve and is partially exposed from the thru-hole, and wherein the fixing sleeve is configured to allow an adhesive to flow into the thru-hole and to further extend to a gap between the inner thread and the outer thread so as to adhere the fixing sleeve and the focus adjustment sleeve.

17. A focus fine-tuning mechanism of an optical engine module configured to adjust a light beam that passes therethrough, the focus fine-tuning mechanism comprising:
a fixing sleeve;
an inner lens fixed to the fixing sleeve and configured to collimate the light beam;
a focus adjustment sleeve movably assembled to the fixing sleeve; and
an outer lens fixed to the focus adjustment sleeve, wherein the outer lens has a concave surface facing toward the inner lens and a convex surface that is opposite to the concave surface, and wherein the outer lens is configured to allow the light beam to pass therethrough so as to form a focused beam that travels along a central axis of the focus fine-tuning mechanism.

18. The focus fine-tuning mechanism according to claim 17, wherein a curvature of the concave surface of the outer lens is within a range from 0.07 to 0.075, and a curvature of the convex surface of the outer lens is within a range from 0.135 to 0.14.

19. The focus fine-tuning mechanism according to claim 17, wherein the fixing sleeve has an inner thread, the focus adjustment sleeve has an outer thread, and the outer thread of the focus adjustment sleeve is rotatably screwed to the inner thread of the fixing sleeve.

20. The focus fine-tuning mechanism according to claim 19, wherein the fixing sleeve has a thru-hole, and the outer thread of the focus adjustment sleeve is partially exposed from the thru-hole, and wherein the fixing sleeve is configured to allow an adhesive to flow into the thru-hole and to further extend to a gap between the inner thread and the outer thread so as to adhere the fixing sleeve and the focus adjustment sleeve.
